(19) United States
(12) Patent Application Publication
(10) Pub. No.: US 2023/0280051 A1
(43) Pub. Date: Sep. 7, 2023

(54) EVAPORATIVE-COOLING AND ABSORPTION-HEATING IN AIR GAPS INSULATION POWERED BY HUMIDITY FLUCTUATIONS

(71) Applicant: Termotera LTD., Amirim (IL)

(72) Inventor: Dror Zchori, Moshav Amirim (IL)

(21) Appl. No.: 18/019,474

(22) PCT Filed: Aug. 5, 2021
(86) PCT No.: PCT/IL2021/050951

§ 371 Date: Feb. 2, 2023

Related U.S. Application Data
(60) Provisional application No. 63/061,190, filed on Aug. 5, 2020.

(51) Int. Cl. F24F 6/02; F24F 7/007; F24F 11/63; E04F 13/00; E06B 7/02; E06B 9/42

(52) U.S. Cl. CPC F24F 6/02; F24F 7/007; F24F 11/63; E04F 13/007; E06B 7/02; E06B 9/42; F24F 2110/10

(57) ABSTRACT

Air gap insulation is a common means of providing thermal insulation from the environment. In many cases the air gap is heated by direct or indirect solar radiation, so ventilating this gap has a cooling effect. The invention cools this gap by integrating moisture-absorption material units that harvest water from the air during the night and provide evaporative cooling during the day. Compared to the ambient air, the daily relative humidity fluctuations in the air gap are more extreme, allowing a significant cooling effect. Furthermore, during the night, humidity absorption on the absorption unit reduces the risk of condensation within the air gap. Additionally the absorption process generates heat, and by using a controller processes of heating, cooling and dehumidifying can be activated when possible and needed.

This application claims priority from US provisional patent application 63061190 filed 5 Aug. 2020.

### 1. FIELD OF THE INVENTION

The present invention relates to the field of energy-saving in buildings using the building envelope.

### 2. BACKGROUND OF THE INVENTION

According to the UN, buildings are responsible for almost 40% of energy consumption worldwide. Yet according to all indicators, the building sector is not on track to reduce this consumption; on the contrary, energy demand in buildings in 2018 rose 1% from 2017, and 7% from 2010. In the EU, buildings are responsible for 40% of energy consumption and 36% of GHG emissions. 75% of the housing stock is energy inefficient and low demolition rates (0.1-0.2% per year) indicate these buildings will remain with us for decades. Moreover, the building stock is set to double by 2050. While energy consumption and technological improvements continue to be made (in accordance with EU energy efficiency directives), they are not adequate to outpace growth demand.

Building energy consumption has been growing exponentially for years. Worldwide, buildings consume more energy than the transportation or industry sectors, accounting for nearly 40% of total energy use in the world.

A large portion of domestic energy expenditure is spent on maintaining comfortable conditions within buildings. Comfort is a function of both temperature and humidity levels. Temperature variations, to a certain degree, are ubiquitous to almost any climate. Thermal mass can be used to maintain stable temperatures, as thermal mass acts as a heat buffer and reduces the peak (maximal and minimal) temperatures in the building. Thermal mass is mostly suitable for climates with large temperature variations and requires the usage of heavy construction elements (stone, earth, water) in order to provide noticeable gains in comfort.

### 3. SUMMARY OF THE INVENTION

When water goes from its liquid phase into the vapor phase it absorbs energy. Symmetrically, when it goes from gas to liquid it releases energy. When water evaporates from a material it absorbs both latent energy and binding energy, cooling the surroundings, and when a material absorbs water it releases energy, heating the surroundings.

The purpose of this invention is to harness this well-known mechanism of evaporative cooling and the less-well-known mechanism of absorption/adsorption heating by using changes in relative humidity to store ambient moisture or dryness for use later when cooling or heating are needed, in a cyclic mechanism that can be used in different embodiments. This approach can be complementary to the use of thermal mass, and like use of thermal mass tends to reduce peaks in temperature variations—but unlike thermal mass, also reduces peaks in humidity variations.

The specific embodiment that we refer to employs a ventilated facade. One specific embodiment comprises a double glass facade, possibly with windows. Various embodiments allow for different ways that absorption/desorption technology can be integrated into these facades for purposes of air conditioning.

The innovation utilizes an absorption material as a storage reservoir, capable of absorbing and desorbing moisture. This reservoir has the potential for heating (through absorption) or cooling (through evaporation), based on the difference between the state of humidity in the ambient air (which can be forced through the absorption material) and the saturation level of the material. As a naturally occurring phenomenon like wind or solar energy, levels of relative humidity change in daily and seasonal cycles. By controlling the flow of air on the absorption material, it is possible to selectively activate it (ie to cool/heat/humidity/dehumidify the air passing through the material), optimizing the energy savings in heating and cooling produced.

### 4. DEFINITIONS

Absorption material: material adapted to absorb relatively large volumes of moisture from the air (or directly from another source of moisture or water). The absorption material can be in liquid form or solid form, a liquid absorbent impregnated into solid material, and the like. Combinations of such absorption material can generally both absorb and desorb moisture for many cycles, heating upon absorption (sorption heating) and cooling upon desorption (evaporative cooling).

The absorption material can be a solid like bentonite, a solution of salts like calcium chloride, an absorbent material impregnated in another absorbent material like plant fiber, or a combination of the above. Absorption materials suitable for use with the system include rice sheets, paper, vermiculite, wood wool, activated carbon, silica gel, cloth, hemp, hemp-lime, cotton fabric, and the like. Many of these may also be improved by impregnation with other absorptive materials such as calcium chloride or lithium bromide. Different combinations may also be used, such as water-absorbing salts combined with materials such as active carbon, wood wool, and bentonite.

Liquid solutions may also work as well, for instance, lithium bromide, aqueous calcium chloride, or calcium chloride in ammonia. Different materials can be designed for different climates. For example, calcium chloride impregnated into vermiculite has good humidity absorption in the dry conditions, while vermiculite impregnated with lithium bromide has good humidity absorption in the humid conditions.

Hygroscopic material: same as absorption material.

Absorption material reservoir: This is a volume containing absorption material. In simple embodiments, the absorption material reservoir is the absorption material itself, while in more complex embodiments the absorption material reservoir may be divided into sub reservoirs that operate separately. In some embodiments, the sorption reservoir is completely insulated from the environment, with all gas exchange prevented. In other embodiments, it is partly sealed or not sealed at all, in which case the sorption saturation level is kept fairly constant due to low rates of mass exchange, compared to forced mass exchange while using the reservoir.

Absorption heating: the process of water vapor binding to absorption material, thereby releasing heat and increasing the moisture content of the absorption material. The energy released as heat is due to a combination of evaporation energy and binding energy.

Ambient air: In most cases, this is outdoor air, outside the structure to be cooled or heated (such as a house or office building). The ambient air may include air in contact with the outer window surfaces, outer enclosure, facade construction, envelope, building, or structure. In general, however, the ambient air may also come from inside the building.

Surrounding air: This is the air that surrounds the system, or air that is outside or inside an object, enclosure, building, or structure.

Source of air: air available for use either inside or outside space, object, or enclosure. For instance, one common source of air is the ambient air outside a building.

Absorbent reservoir: a quantity of absorption material that can be fully, partially, or not at all encapsulated and thus insulated (with respect to moisture transfer) from the surrounding air. The absorbent reservoir can be divided into subunits.

Airpath: a flow path for air conduction. For example, one air path may be used to expose absorption material to ambient air, by providing a duct and fan or other means for conducting air from the ambient past the absorption material.

Flow system: A system adapted to control a flow of air or other gasses, water, or both.

Absorption material saturation level: This is a measure of the moisture content of the absorption material. This is most usefully measured in terms of the relative humidity of a body of air in equilibrium with the absorption material - thus for instance a 50% saturation level of a given volume of the absorption material, indicates that air in equilibrium with this volume of absorption material would reach a level of 50% relative humidity.

Means for evaluating the saturation level of said absorption material: A sensor or sensors adapted to determine the state of moisture absorption of absorption material. This can be a humidity sensor, conductivity sensor, capacity sensor, salinity sensor, volume sensor, specific gravity, viscosity, scale, or any other sensor that indicates the amount of water in the absorption material. A relative humidity sensor for air that is in equilibrium with absorption material is an example of a simple means for evaluating the saturation level of said absorption material.

By keeping a record of the humidity of air incoming to and outgoing from the absorption material, the saturation level of the absorption material may be estimated. Alternatively, a humidity sensor may be placed in close contact with the absorption material, and the humidity reported by this sensor will generally be close to the saturation level of the material. A further alternative may be to measure weight gain or lost by the absorbent material, or to use an absorbent material that changes color as it absorbs and desorbs material.

As mentioned, in order to easily compare the saturation level of the absorbent material with the relative humidity of a given body of air, the saturation level is best expressed in terms of the relative humidity of a body of air in equilibrium with the absorption material.

Monitoring water saturation level: As mentioned, determining the saturation level of the absorption material may be accomplished with saturation sensors, or by sensing the temperature or humidity difference of air before and after heat and mass exchange, from which the moisture transfer can be calculated and integrated over time. Alternatively, this may be accomplished by estimating the saturation level using records saturation level and/or performance (in terms of outgoing temperature and relative humidity) of historical operations.

Vent: The inlet and outlet for air to enter into and exit from the system. The vent can be divided into several sub-inlets and sub-outlets. The vent (air inlet or outlet) can be an unobstructed path for air to reach the absorption material, and may include a valve and/or flow control means such as a fan. The air inlet can have several sources of air for one system as indoor air, outdoor air, specific conditioned air, and so on. In such cases, the controller of the system can choose between air sources. The outlet can have only one sink for one system. The vent may include ducts to route air along paths (such as one duct to allow an air flow from an ambient source outside a building, into the building envelope, and another duct allowing air flow from within the building envelope to the outside).

In one embodiment of the invention, there is only one air source, and the air sink and source are alternated. Thus the airflow direction is periodically reversed, thereby performing heat and mass recovery. For instance, air is alternately conducting into an air gap from the ambient, and then out of the air gap to the ambient.

Advanced algorithm: an algorithm that optimizes the system operation. Some non-limiting examples include:

Algorithms to match cooling and heating supply to demand; algorithms using user-behavior patterns (e.g. learning different ‘comfort zones’ or values of acceptable temperature and relative humidity, for different people), algorithms using AI or other means to predict future cooling/heating requirements, algorithms using AI or other means to estimate future humidity/temperature levels of the available ambient air, water-saving algorithms, and combinations of these.

An advanced algorithm can also take into consideration the local, current cost of energy, to minimize yearly energy expenses.

An advanced algorithm can also use the weather forecast to prepare the system for expected requirements in the future; for instance, if a heatwave is expected, cooling on a relatively cool day may be skipped in order to save water for the upcoming cooling requirements during the heatwave.

Water-saving-algorithm: an algorithm that is used for reducing the use of the water harvested in the absorption material. One non-limiting example of such an algorithm is:

If the temperature in the air gap has not reached a cooling threshold (i.e. cooling is not needed) then the absorption material is not exposed to the incoming ambient air stream. Thus there is no cooling when it is not needed, and consequently no waste of the water absorbed in the absorbent material. If the temperature of the gap has reached the cooling threshold (i.e. cooling is needed) then the airflow rate can be reduced to the minimum needed to cool the air just to the threshold temperature, avoiding over-cooling the air. This also tends to conserve the moisture absorbed in the absorbing material, for later use if needed.

The exposure can be limited by reducing the airflow as mentioned, or by using exposure restriction means if there are present.

FIG. 17 shows results of a simulation of the system , using a finite-differences method to calculate the changes in saturation level of the absorption material as a function of relative humidity and temperature of the incoming air flow, and similarly to calculate the outgoing airflow temperature and relative humidity.

The figure indicates unnecessary cooling times (16). Only at point 17 is cooling actually needed; thus a better algorithm will only route incoming air through the absorbent material at point 17, and not at point 16.

FIG. 16 shows a specific embodiment when the absorption material is on the blinds so the exposure can be restricted by simply controlling the blinds.

User-behavior pattern data: data concerning user behavior such as setpoints chosen, times of building occupancy, and the like. User-behavior pattern data can serve an advanced algorithm.

Energy consumption or energy costs: the controller may take into account energy usage and/or energy costs. Due to tariff differences, the energy use does not necessarily correlate with energy cost; it is within the provision of the invention to take this into account when planning optimal actions.

Forecasts future: the system has a controller adapted to estimate the system's current and future capability to meet target conditions, and to take actions that allow for meeting current and future predicted requirements. A non-limiting example involves periods when a cold snap is expected; in these cases it will be useful to dry the material previous to the cold snap, such that it can be used for heating.

Water-harvesting-mode and cooling-mode require certain conditions. For water-harvesting (which also provides heating), the absorption material must be relatively dry (drier than the air being used to flow through it, or in other words the saturation level of the absorbent material must be less than the relative humidity of the air flow), while to cool it must be moist (more humid than the air being used to flow through it, or in other words the saturation level of the absorbent material must be greater than the relative humidity of the air flow). The water harvesting mode involves running relatively moist air through or past the absorbent material to moisten the material. Cooling mode involves running relatively dry air through or past the absorbent material, drying the material and cooling the air.

Waiting-mode: waiting-mode occurs when the flow control system does not allow or cause airflow. Under many conditions even if the absorption material is not in an airtight enclosure, the exchange rate is negligible if there is no forced airflow and heat exchange.

Thermal mass storage: the system has thermal mass which can be used for heating or cooling. Airflow may be used (for instance) to cool the material at night, and then cool a dwelling during the day with air-cooled by being blown through or past the cooled material.

Active insulation refers to an insulation layer (such as that surrounding a building), that under some conditions, can heat up or cool down in a controlled fashion and thereby reduce dramatically the heat loss of the building. This layer is not only insulating but can heat or cool in a controlled, on-demand fashion by venting dry or humid air as described above. It can be implemented in roofs, walls, and even car roofs.

A ventilated air gap is a gap between walls or other elements, this gap being filled with air largely or entirely separated from the outside environment, and through which air can flow. Non-limiting examples of ventilated air gaps include ventilated facades, double skin facades, and ventilated roofs having interior air spaces. Such ventilated roofs are heated by solar radiation and often ventilated by natural or forced convection.

Air gap or intermediate cavity of double-glazed windows or double-skin-glass-facades: this is the gap between two sheets of glass, in a double glazed window or in a double glass facade. In principle this is similar to the ventilated air gap above although often such windows are produced without provision for air flow through the air gap.

Means for facilitating airflow: devices for creating forced air flow. There are many means suitable, including active means such as blowers or fans, and passive means such as solar tubes, convection devices, wind-powered roof vent turbines, and assisting devices such as ducts and dampers.

Absorption-material-unit: A device adapted to facilitate absorption/desorption of moisture from a volume of absorbent material. There are many conceivable embodiments for an absorption material unit:

The absorption material unit can simply be the absorption material itself. For example wood wool or wood wool impregnated with calcium chloride or hemp-lime/hemp-clay can suffice; the wood wool has sufficient structural integrity that no external structure is needed to contain it.

Alternatively, the unit can be a ventilated container (e.g. a metal or plastic box) that contains loose absorption material particles such as silica gel.

Alternatively, the absorption material can take the form of a sticker, for instance, that is attached to blinds or attached to the side of a wall, air path, or window.

Some further non-limiting examples:
The absorption material unit is a ventilated container filled with particles of absorption material, disposed in a way that allows an appreciable airflow to pass through or past said particles. Generally speaking this can be done by providing air channels or large porosity in the absorption material.
The absorption material unit is made of porous absorption material, allowing an airflow to pass through it.
The absorption material unit is made of absorption material and placed inside an air gap (e.g. of a ventilated facade) such that air can pass along the side of the (for instance rectangular) absorption material. By passing air along the side instead of through the absorption material there is minimal airflow interruption. The absorption material can include fines (i.e. fine particles) and/or high-surface area shapes, for increasing surface area.
The absorption material may be transparent, and/or of a color-changing material dependent upon the saturation level.
The absorption material may also serve a decorative purpose.
The absorption material unit may take the form of a container having vents or ducts allowing air to flow from an air gap and back to the air gap.

Fins for absorption materials: The absorption material may comprise projections such as fins or spikes to increase surface area and promote moisture exchange. A non-limiting example of the use of fins is in the case of airflow directed to the side of the absorption unit instead of through it. In this case, having fins can increase the surface area involved in surface exchange, for more efficient mass transfer.

Projections adapted for increasing surface area: These are any projections adapted for the purpose of increasing particle surface area. A non-limiting example is use of high-curvature and/or extremely fine particles. Such embodiments can be used when air flows on the side of the absorption material.

Exposure-restriction-means: These are means for limiting exposure of the absorption material to an air flow. A non-limiting use case is if there is an airflow that goes through an air gap and the absorption material unit is inside the gap, then the restriction means can control if the absorption material will be exposed to the airflow and exchange humidity with the air that flows through the gap, and if it does, then to what extent. For example, an electronically controlled baffle or valve can be used for this purpose. A practical use case is when one wants to prevent the gap from reaching a certain temperature limit by forcing air through it, but we don't want to waste the water moisture stored in the absorbent material (for example when the air stream has a lower relative humidity than the saturation humidity of the absorption material). In that case, the exposure restriction means can act in two ways:
1. If the temperature in the air gap has not reached the cooling threshold (above which the system needs cooling), then the control system does not expose the absorption material to the air flow—so there is no cooling if it is not needed, and water moisture in the absorption material is saved for future use.
2. If the temperature of the gap has reached the cooling threshold (so cooling is needed) then the control system provides that air flow needed to cool the air down just to the threshold temperature, and not under - thus again preserving a maximum amount of moisture for future use in the absorbent material.

The absorption material saturation level or air above absorption material relative humidity refers to the relative humidity of air that is in equilibrium with the absorption material.

The predetermined cooling threshold is a settable temperature of the air in the air gap above which cooling is provided by the system, if possible. This is analogous to the upper temperature setting of an analog AC thermostat, above which the AC unit provides cooling.

The predetermined heating threshold is a settable temperature of the air in the air gap below which heating is provided by the system , if possible.

Porous humidity absorbent insulation : This is material that acts both as heat insulation and hygroscopic material. A few non-limiting examples for porous humidity absorbent insulation include: wood wool, hemp insulation, wood fiber insulation, paper insulation, cellulose insulation, and hemp-lime.

The insulation material above can also be impregnated with absorption salts. Non-limiting examples include calcium chloride or lithium bromide.

Double-walled glass insulator is a double-glazed window or double-skin-glass-facade or multilayer glass window.

Upstream temperature and humidity sensors: These are temperature and humidity sensors placed towards the source of the airstream, just before it enters the absorption unit. In the case of an air gap, the gap temperature and humidity will generally vary as a function of height. In order to select between the different modes of controller operation, the controller needs to have temperature and humidity information concerning air in the gap air just before it enters the absorption unit.

### 4. Non-Limiting Embodiments of Evaporative-Cooling and Absorption-Heating Ventilated Facade

FIG. 1a illustrates a conventional ventilated facade with insulation material. In a normal ventilated facade, natural air convection occurs through the air gap due to temperature and pressure gradients. When the air gap becomes warmer than the environment, natural convection allows exchange between ambient air and hot air in the gap, cooling the space between the facade and the insulation. thereby reducing the heat loads and saving energy on cooling.

In our innovation, alongside the heat exchange (as in the conventional ventilated facade) there is also humidity exchange with a hygroscopic water-absorption material adapted to maximize humidity exchange. When the incoming air is dry, and the absorption material is saturated with water, then water will evaporate into the relatively dry air and cool the envelope of the building to a colder temperature than would occur with heat exchange only, as in the conventional ventilated facade.

Furthermore, when the air is humid and the absorption material is dry, humidity from the air will absorb into the hygroscopic material, heating the material and the air, which effect can be used for heating in winter.

Controlling both phenomena of evaporative cooling and absorption heating, alongside regeneration of the absorption material for the next expected requirement is a part of the novelty. We will discuss few general embodiments and a combination of our innovation in a ventilated facade:

### 1. Ventilated Facade ‘When the Airflow is on the Surface of the Absorption Material’

FIG. 1b and FIG. 2b illustrate an embodiment where an absorption material is installed in the air gap between the outer facade and the building wall. In other similar embodiments, the absorption material can be attached to the inner side of the facade. In some embodiments, the facade itself can serve as an absorptive material or absorption layer.

In either case, the absorption material can be a thin layer of a few millimeters or a thick layer of several centimeters and can provide thermal insulation and even thermal mass. The airflow within the air gap can be natural, forced, or combined.

In the ‘when the airflow is on the surface of the material’ type of embodiments, heat and humidity exchange occur on the surface area of the material. Humidity can be exchanged between air and hygroscopic material, at the surface area and the inner layer of the absorption material. This exchange can occur by capillarity, concentration differences, and other similar mechanisms of fluid transfer.

Some non-limiting examples of the absorption material:

The absorption material can be for example implemented as plasterboard, sheets, or coatings. The absorption material surface area can be enlarged in different ways such as high-pressure blowing, to increase the porosity of the material layer and allow faster heat and mass transfer.

In one embodiment the absorption material can be the material of the facade itself, which can have an absorptive property or absorption layer coating the facade elements.

The absorption material may be a salt such as calcium chloride, a highly porous inert material such as vermiculite, pumice or other minerals, artificial materials such as blown concrete, or combinations of such materials.

### Another Non Limiting Example When the Airflow is Over the Surface of the Material

FIG. 14 illustrates an option where an absorption material is installed in the air gap, dividing it into two air sections and the heat and mass exchange is on the surface of the absorption material, airflow can be in two different directions from ‘a’ to ‘b’ or from ‘b’ to ‘a’ on top of that air source and air, sink can be indoor or outdoor so there are few embodiments:
1. airflow from outdoor to outdoor;
2. airflow from indoor to outdoor;
3. airflow from outdoor to indoor;
4. airflow from indoor to indoor;

The most simple embodiment has just one option where the airflow is from outdoor to outdoor so there is no need to involve a hole in the wall.

Other embodiments can have a combination of airflow sink and source.

The absorption material can be impenetrable for air and water from one side' so heat and mass exchange can occur only at one air gap. if it is impenetrable on the outer gap it can prevent rain watering problems.

### 2. Ventilated Facade When Airflow is Going Through a Porous Absorption Material

FIG. 1c and FIG. 2c illustrate an embodiment where an absorption material is installed in the air gap, dividing it into two air sections:

There is a ‘first air gap’ between the facade and the insulation material and a ‘second air gap’ between the absorption material and the wall. The absorption material can be a thin layer of a few millimeters or a thick layer of several centimeters and can possess properties of insulation and/or thermal mass. In an embodiment that can be seen in FIG. 2c, air can flow through the absorption material, allowing heat and humidity exchange between the airflow and the absorption material. For that to happen, the absorption material should have airflow channels, or be sufficiently porous to allow air to flow through it.

Some non-limiting examples for the absorption material are:

The absorption material can be for example implemented in the form of plaster, boards, sheets, or coatings.

The absorption material surface area can be enlarged in different ways to allow faster heat and mass transfer, for example by increasing the porosity of the material or providing it with airflow channels.

One specific non-limiting example for the absorption material uses ‘wood wool’ insulation or cellulose insulation, which are absorptive materials. The insulation can act as absorption material by itself, or its absorptivity can be increased by impregnating it with a highly absorbent material such as calcium chloride.

FIG. 4 shows a non-limiting example of a ventilated facade with two air gaps

FIG. 5 shows a close look at FIG. 4 non-limiting example of a ventilated facade with two air gaps.

### 3. Combining 1 and 2

If a ‘Ventilated facade when airflow is through the material’ embodiment is installed, it may be used with a dedicated airflow system and controller. Air can either flow through the absorption material, or just on one side of the material, either through the first gap or the second gap.

### 4. Building-Integrated Photovoltaics (BIPV) as the Facade

There are many different building facade, and are system can be implemented using all of them.

For a Building-integrated photovoltaics (BIPV) there is another advantage for using this system since it can cool the photovoltaic panels thereby increasing their energy output.

In this way, the system advantage is both by reducing the heating and cooling loads, and by increasing the energy output from the photovoltaic panels.

### 5. Non-Limiting Embodiments of Evaporative-Cooling and Absorption-Heating Double Glass Facade and Double Glass Windows

Double glass facades and double glass windows can act like a greenhouse, trapping heat and creating large thermal loads. Ventilating the gap between the glasses can reduce to some extent these loads, while using the technology described here can further reduce these heat loads.

FIG. 6a shows an example of the temperature that can develop through the double glass facade (the temperatures in the figures are only for the purpose of discussion).

FIG. 6b shows a non-limiting example of our innovative idea of integrating absorption material into the glass facade.

In this non-limiting example, absorption material is integrated between the floors, so it doesn't block the view

By controlled operation of an air blower that blows air through the air gap the integrated absorption material can go through the following cycle:
1. water-harvesting-mode at the night phase—absorbing humidity from the air thereby:
   a. heating and drying the air gap between the glass so the risk for condensation is reduced, and reducing the heat loads in the wintertime.
   b. absorbing water so that it can be used for a day's evaporative cooling.
2. cooling-mode at the day phase—evaporating absorbed water to the air gap thereby:
   a. cooling the air gap thereby reducing the heat loads on the budding envelope.
   drying the absorption material so it can dry and heat the air gap during the night, thereby reducing the risk of condensation and reducing the heat loads in the wintertime.
3. repeating the night phase and day phase as long as needed.

This cycle of operation can be controlled by operating or not operating the blower, and when operating it by operating it at different speeds.

controlling the blower in this manner can improve the system results. For example, cooling only when is needed and in the intensity that is required so the water reservoir is kept saturated as much as possible.

A basic control system can be by measuring the air gap temperature more advanced algorithm can predict the energy-saving effect for a specific moment and for year-round and calculate the action that will bring to the maximum energy saving.

The water reservoir can be designed for a few days of operation so even when the humidity at night is not high enough it can still use the humidity that was stored from days or weeks before.

According to a first estimation, our unit can dramatically reduce the air temperature inside the double screen. Furthermore, it has the potential of reducing the number of hours with condensation risk in a year.

Non-limiting embodiments include the following:
1. FIG. 7 shows a unit of a double glass wall where the absorption material is integrated into the frame of the glass wall.
2. FIG. 8a shows a glass wall where the absorption material is integrated between the floors, it can be on all the floors or a specific floor. FIG. 8b shows a closer look at the absorption material and the air movement.
3. FIG. 9 shows an application of the innovative idea to windows. Installing absorption material into multi-glazed windows is actually not new, and is usually done to prevent condensation. But blowing air over it to reduce heat loads (by cooling or heating the air gap, using absorption/desorption heating/cooling) is innovative.

The frame of the window can contain absorption material.

Small controllable vents and blowers can direct the air for the night phase or the day phase.

Blowing air from the ambient, throughout the absorption material, and then back to the ambient is all that is needed for our invitation to operate.

More advanced systems can use the indoor air as well and/or have an air path from the ambient air to the indoor air so the window can control the fresh air and improve indoor humidity levels.
4. The absorption material can also comprise a thin layer placed along one side of the glass when visibility is not an issue (for example between the wall). If for example, the floor-ceiling thickness is 60 cm then the absorption material can be a thin sheet covering all the 60 cm of the floor-ceiling thickness. the thickness can be few mm to few cms, and the airflow, heat and mass exchange can be on the side of the material.
5. transparent absorption material, silica gel is transparent, absorption material that can be transparent can be implemented on all the surface of the glass, thereby increasing the surface area for heat and mass transfer.
6. In all the embodiment, there could be a dedicated air path that allows air to flow from the ambient through the absorption material and then back to the ambient without passing through the air gap between the glass of the window, thereby regenerating the absorption material without changing the window temperature. In this embodiment, a controller control if the air below just through the absorption material or through the air gap between the glass of the window as well

### Simplified Calculations for Presenting the Concept Let's assume that we have a saturated absorption material on the 12 m height.

Step 1: sensible heating by the solar radiation:

let's assume that the ambient air temperature is expected to rise from 30° at the bottom to 50° c at 12 m height as can be seen in FIG. 6.

Heating the ambient from 30° C. to 50° C. will reduce the relative humidity from 70% to 25%, as can be seeing from the psychrometric chart in FIG. 10.

Step 2: Evaporative cooling by ThermoTerra unit:

By integrating a ThermoTerra unit at 12 m height, an evaporative process can occur. As can be seen on the psychrometric chart in FIG. 11 by increasing the relative humidity from 25% to 50% air temperature drops from 50° C. to 40° C.

Discussion:

From the last example it can be seen that by implementing evaporative cooling at 12 m height, the air temperature inside the wall can drop by 10° C.

The cooling potential can be even greater: for example, increasing the relative humidity to 70% air temp can drop to 35° C. or if increasing the relative humidity to 90% air temp can drop to 30° C. as the illustration in FIG. 6

### 6. Operation and Regeneration

This chapter refers to all the different embodiments presented above, for a ventilated facade, windows, or double glass facade.

### 6.1 Strategies for Avoiding the Negative Effect of Regeneration

When charging for further heating (removing moisture from the hygroscopic material), evaporative cooling occurs that could be unwanted.

When charging for further cooling (adding moisture from the hygroscopic material) there is absorption heating that could be unwanted as well.

To deal with these situations, there are two strategies that can be executed:
1. Higher fan speed

For a certain amount of absorption material, saturation level, and humidity condition, there is a certain maximum mass transfer speed that water absorbs or releases. If air is blowing over the absorption material very quickly (the convection mass transfer is higher then the evaporation/absorption mass transfer) then the effect of cooling or heating will have less impact on the temperature of the air leaving the absorption material. This is one way to overcome the negative effect regeneration could have.
2. Changing the airflow direction

FIG. 3a shows first-airflow-direction when a low fan is sucking the air so that airflows first to the wall and then to the absorption material, so the modified air (cooled or heated) does not affect the wall. This is the activation mode. This specific way of regeneration is another way to overcome the negative effect regeneration could have.

FIG. 3b shows second-airflow-direction when a top fan is sucking the air so airflows through the absorption material and after it has been modified (cooled or heated) it cools or heats the wall. This is the activation mode.

and the controller configured to operate said water-harvesting-mode in said first-airflow-direction and said cooling-mode in said second-airflow-direction in the summertime, thereby night water harvesting heating effect does not heat the building in the summertime.

That can work as well in the wintertime to avoid cooling during the charging for further heating.

### 6.2 Pulse Activation Strategy for Increasing Unity in the Absorption Material Saturation Levels

When blowing air across the absorption material the ‘first’ material to get in contact with the air will change the air humidity so that the ‘second’ absorption material will be in contact with air in different humidity and in time will have a different saturation level across the absorption material. This can create a problem especially in the Ventilated facade ‘when the airflow is on the surface of the material’. In order to prevent that, one way is to blow the air in relatively high-speed air pulses. so air gets to the ‘second’ absorption material with having less influence by the ‘first’ one (and so no with the rest of the material). The pause between the pulses should be long enough to allow a good mass exchange between the air and the absorption material.

This method can reduce the lack of unity in the absorption material.

### 6.3 Free Cooling And Free Heating Strategy

Having the option to blow air over the wall can enable the following strategies:
1. Free cooling (night cooling) when during the summertime night the outdoor air can cool the thermal mass of the building (if it's cold enough).
2. Day heating when during the wintertime days the outdoor air can heat the thermal mass of the building (if it's warm enough).

Free cooling and free heating normally can store ambient conditions in the thermal mass of the building.

In our innovation, we can store not only the ambient conditions but also the modified ambient conditions that can be done by evaporative cooling and absorption heating that our system can perform. This strategy like all the other strategies can work together when there are a controller and algorithm managing all the different possibilities so as to reach maximum energy saving and comfort feeling for the inhabitants.

### 6.4 A Specific Non-Limiting and a Non-Binding Case Where the Air Source is the Indoor Air

For operation the above innovation, air source can be one of the different air sources. under this paragraph, we will show the advantage of combining the indoor air source and the ambient air source.

The outside environment has humidity fluctuations, to some extent; using the indoor humidity as a second source dramatically increases the available humidity fluctuations and thereby the system performance.

Using the ‘used’ air from the building:

When fresh air, is forced into the room then ‘used’ air, must be evacuated.

In the summertime, if the indoor air is cooled then it is usually dry as well. If some of the indoor air needs to be evacuated (when fresh air is forced to the room for example) then this air can be directed to the absorption material. When the dry cold air comes with contact with the absorption material it further cools so we have air that is even colder air the indoor air. This cold air can reduce the building envelope temperature and can save on cooling energy.

Heat exchange between the ‘evaporative cooled indoor air’ to the incoming fresh air.

There is also the possibility to further use the indoor air that went through evaporative cooling air for indirectly cool the fresh air coming to the building.

FIG. 12 shows one non-limiting example where indoor air is directed into the air gap between the wall building and the insulation material.

The indoor air can be also directed to the air gap between the absorption material and the facade in or if it is a ‘Ventilated facade ‘one side airflow’ it can be directed to the absorption material where it is located.

FIGS. 13 and 14 show non-limiting examples where the air can go, after being forced over the absorption material: to the first gup and then outside in FIG. 13 (it can also be first to the second gap and then to the first) or back to the room in FIG. 15

in these embodiments, the absorption material can be impenetrable for air and water from one side' so heat and mass exchange can occur only at one air gap.

if it is impenetrable on the outer gap it can prevent rain watering problems.

A non-limiting example of a combination of the airflow in the summertime can be using the ambient air at the night to absorb humidity.

In the wintertime, indoor humidity can be used for heating. From a paper on Thermochemical Energy Storage, we can see that: “The daily humidity production of 4 people living in a building can be assumed to be 10.4 kg per day (Hartmann, 2001). Hence the average building air humidity is almost 2 g water/kg air higher than the outdoor air humidity.”(H. Kerskes at all 2011). This means that it is possible to use this humidity fluctuation in order to heat in the winter and at the same time reducing the risk of condensation in the building.

This idea can be used in ventilated glass facades and windows.

### 6.5 Controller, Algorithm, and Learning Algorithms

All the above strategies can work together when there is a controller and algorithm managing all the different possibilities so as to reach maximum energy saving and comfort feeling for the inhabitants. There are many parameters to consider, a simple algorithm can consider:
1. The expected or measured temperature of the air gap (air gap' in FIG. 1b or ‘second air gap’ in FIG. 1c)
2. Measure or calculate the temperature of the air after it was modified by our system and operate the system if it will save energy.

For the regeneration, the geotherm can execute regeneration if the total outcome is beneficial in saving energy and use one of the above strategies for avoiding the negative effect of regeneration.

A more advanced algorithm can:
consider the coming meteorological forecast for preparing the system for further use.
consider the inhabitant preference by data input, control panel or learning algorithm.
can employ learning algorithms to estimate the best combination of strategies and their timing in order to maximize energy-saving and thermal comfort.

The controller can be separated for each side of the building that has different exposure for sun and wind, for wall or segment of wall that can be influenced by different activities or different user preferences.

### Non Limiting Examples of Wintertime Operation Algorithm

Some operation algorithm can take advantage of, or reduce the heating effect on the facade by the sun's radiation.

A non-limiting example for an operating regime in the wintertime:
i. If there are clouds—Lower blower (FIG. 3a) may be activated if the outdoor air is hotter than the air inside the gap, as in the FIG. 3a.
   1. Activation Peak speed as long as the humidity of the outgoing air is higher than the incoming humidity (meaning that there is drying the absorption material—regeneration for the night time) suppose up to 10 percent difference.
ii. If there is a sun—operating the top blower

Operating the blower (FIG. 3b) for a few minutes at optimum speed and checking what the air temp exits from the absorption material.
1. If the temp is higher than inside the building—operating the blower at optimum speed or above peak speed (as long as the temp does not fall below the indoor temperature).
2. If the temp is lower than temp indoor but higher than the outside—operate at minimum speed.
3. If the incoming air temp is less than outside air temp—operate the low fan as in FIG. 3a

### 7. Specific Non-Limiting and Non-Binding Improvements for the Above

### 7.1 Construction as Airflow Channels

The facade construction can be a part of the airflow channel. The construction is usually made from a hollow aluminum frame through which air can flow. This way, air can be brought to or taken from the air gap or gaps in the ventilated facade.

### 7.2. Controlled Connection to the Indoor

In all of the above embodiments, there is a possibility to have a controlled connection of absorption material to the indoor environment. Those embodiments can bring the indoor environment closer to the comfort level of both humidity and temperature.

For such a system to operate optimally, there should be a dedicated controller, fans, vent, sensors, and algorithms all adapted to force airflow from the absorption material into the indoor environment and improve the inhabitant's comfort feeling. The algorithm will generally have inputs comprising temperature and humidity of the outdoor air, indoor air, and air gap; moisture or equilibrium humidity level of the hygroscopic material or several such levels; and the desired level of indoor temperature and possibly humidity.

An appropriate fresh air supply and air quality level can be one of the targets for a suce system, an algorithm that can employ air quality sensors and activity sensors for saving energy and increasing air quality.

### Figures

FIG. 1 shows:
   a. normal ventilated facade;
   b. evaporative cooling and absorption heating ventilated facade with ‘when the airflow is on the surface of the material’ and surface humidity exchange;
   c. evaporative cooling and absorption heating ventilated facade with two side airflow and ‘inside the material’ humidity exchange
   1-fseade, 2-air gap, 3-second air gap, 4-insulation, 5-absorption material, 6-wall

FIG. 2 shows the airflow path and humidity exchange of:
a. airflow path of a normal ventilated facade;
b. airflow path and humidity exchange of evaporative cooling and absorption heating ventilated facade with ‘when the airflow is on the surface of the material’ and surface humidity exchange;
c. airflow path and humidity exchange of evaporative cooling and absorption heating ventilated facade with two side airflow and ‘inside the material’ humidity exchange.
4-insulation, 5-absorption material, 6-wall, 7-mass exchange

FIG. 3 shows a non-limiting example of the airflow path for activation and regeneration mode.
a-airflow for regeneration (for further cooling or further heating)
b-airflow for activation (cooling or heating)
1-fseade, 5-absorption material, 6-wall, 7-option for top fan, 8-option for lower fan

FIG. 4 shows a non-limiting example of a ventilated facade with two air gaps

FIG. 5 shows a close look at FIG. 4 non-limiting example of a ventilated facade with two air gaps

FIG. 6a shows an example of the temperature that can develop through the double glass facade

FIG. 6b shows a non-limiting example of our innovative idea of integrating absorption material into the glass facade.
2-air gap, 5-absorption material unit, 8-temperature and humidity sensors upstream and in adjacent absorption material unit

FIG. 7 shows a non-limiting example of a unit of absorption material integrated into a double glass wall and have air connection with the ambient air and/or the indoor air
9-a unit of absorption material integrated into a double glass wall and have air connection with the ambient air and/or the indoor air

FIG. 8a shows a non-limiting example of a glass wall where the absorption material is integrated between the floors, it can be on all the floors or specific floor.

FIG. 8b shows a closer look at the absorption material and the air movement.

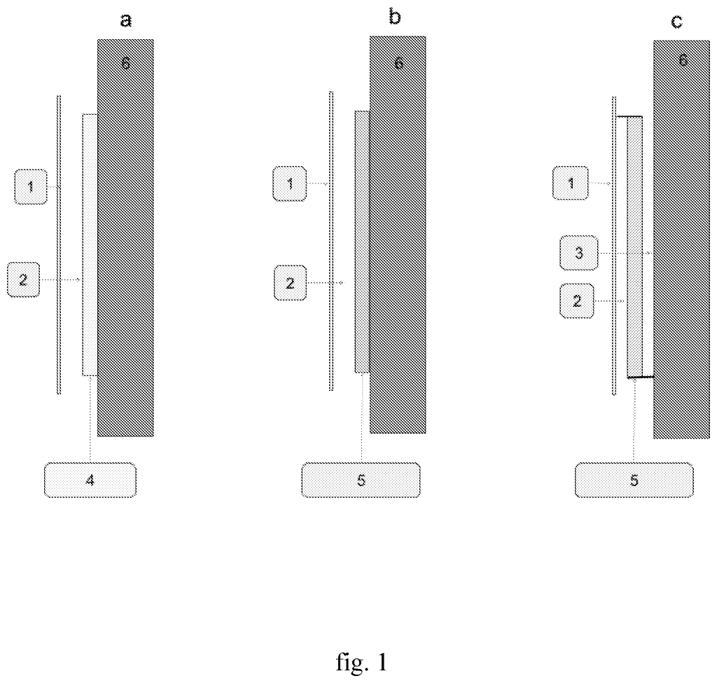

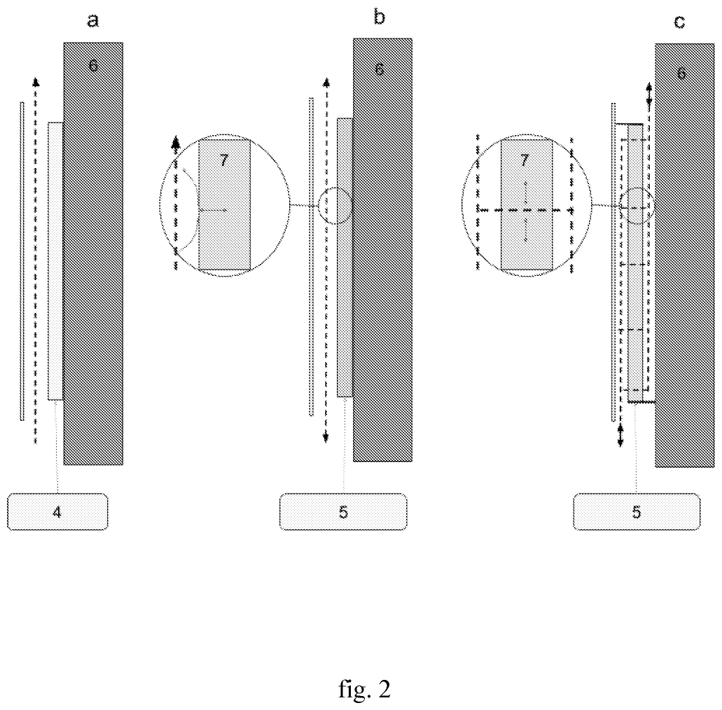

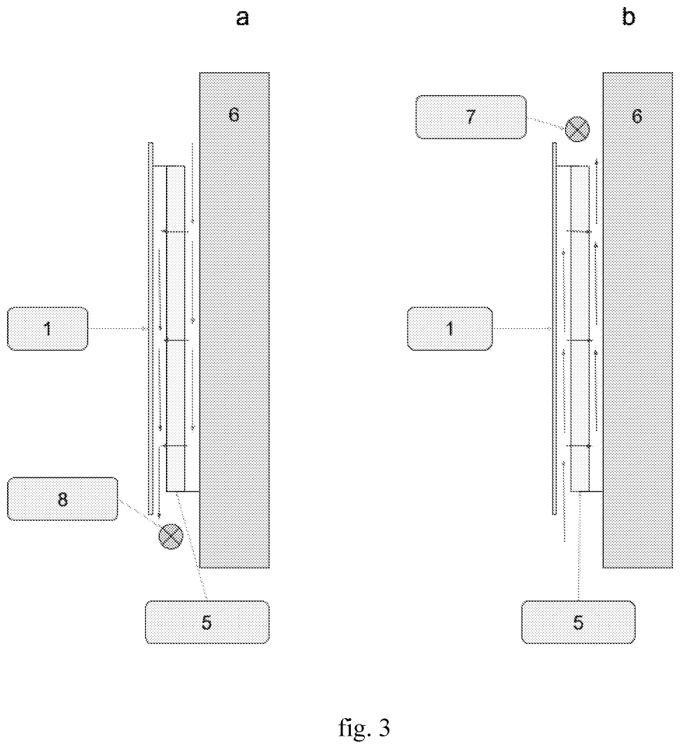

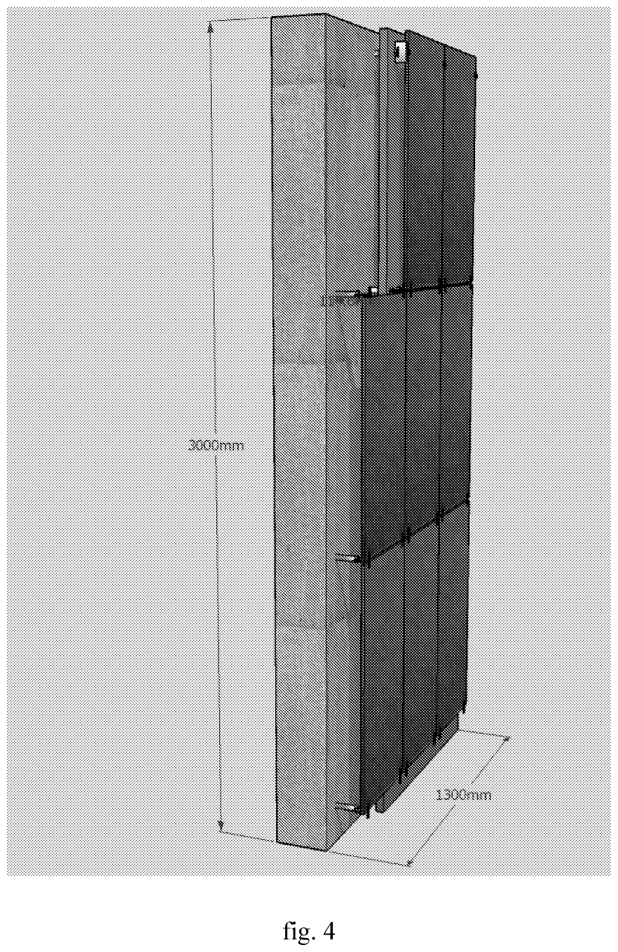

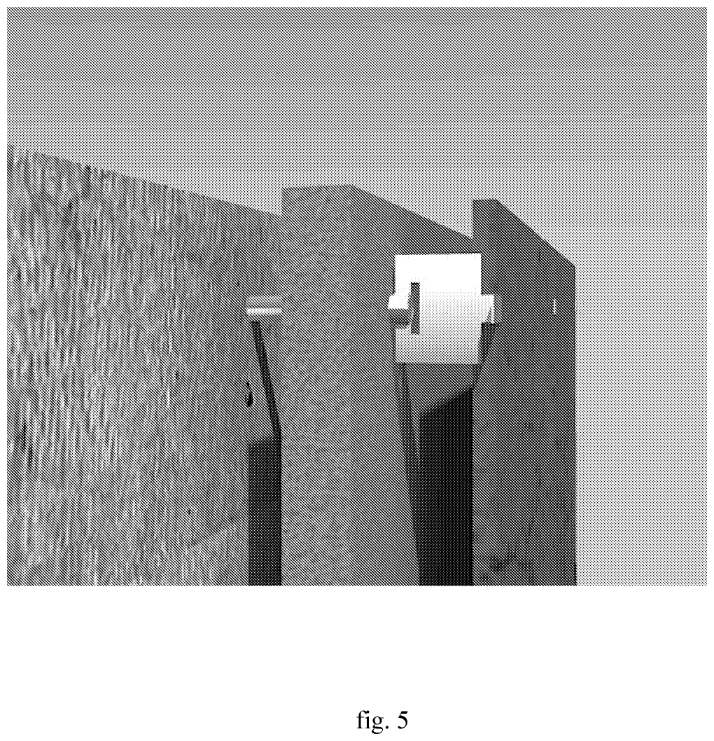

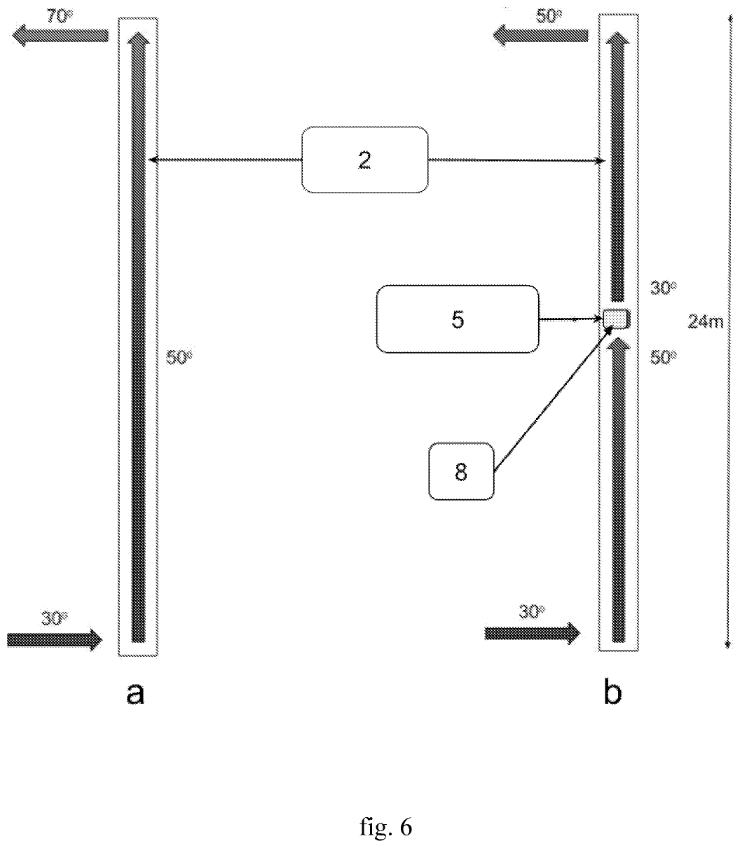

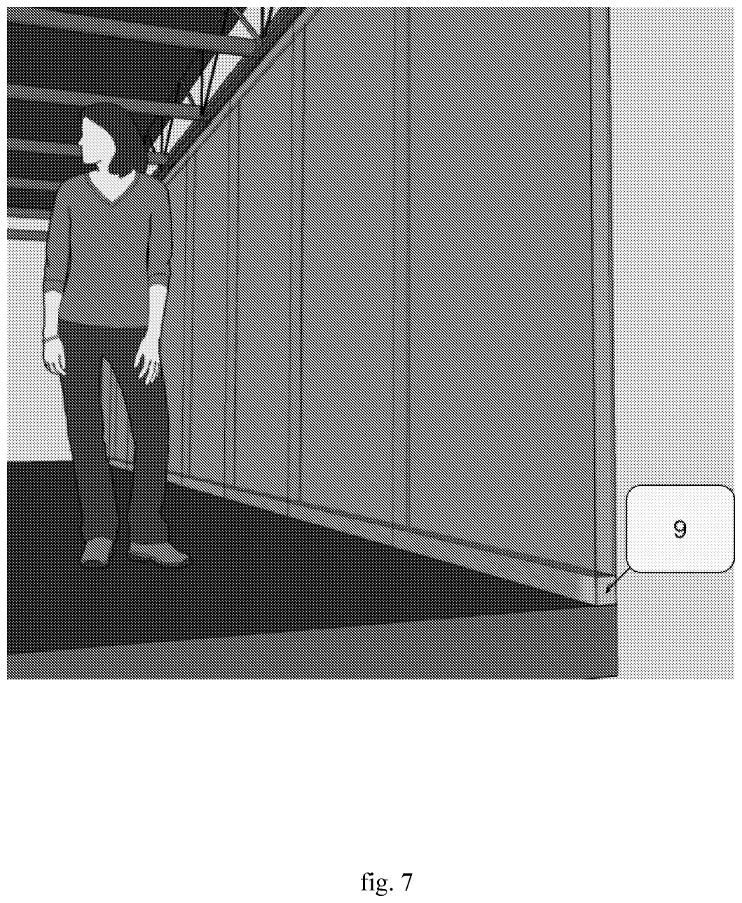

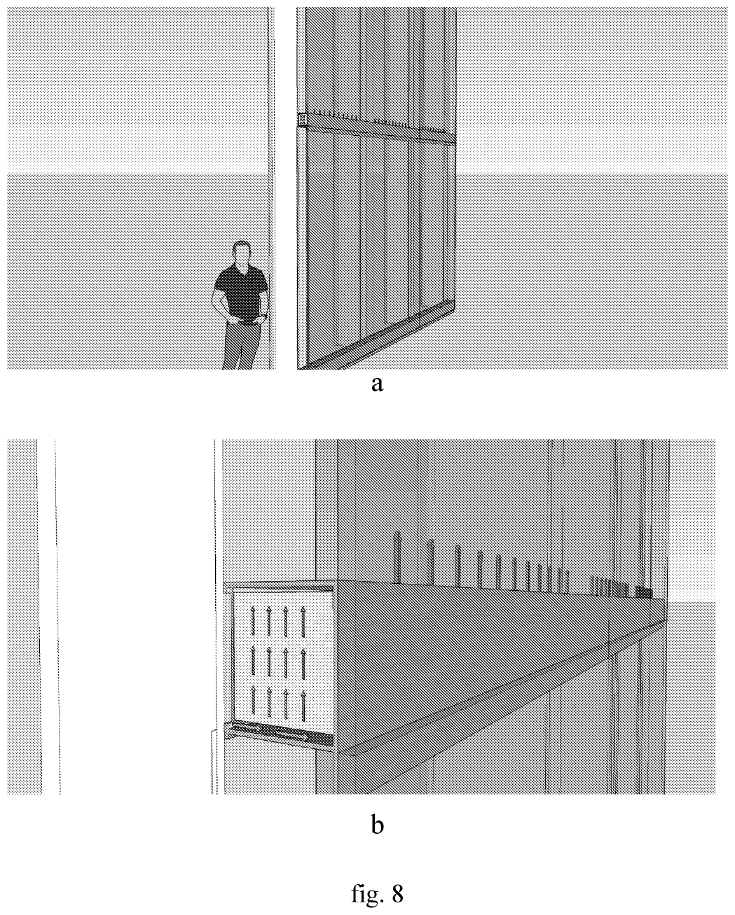

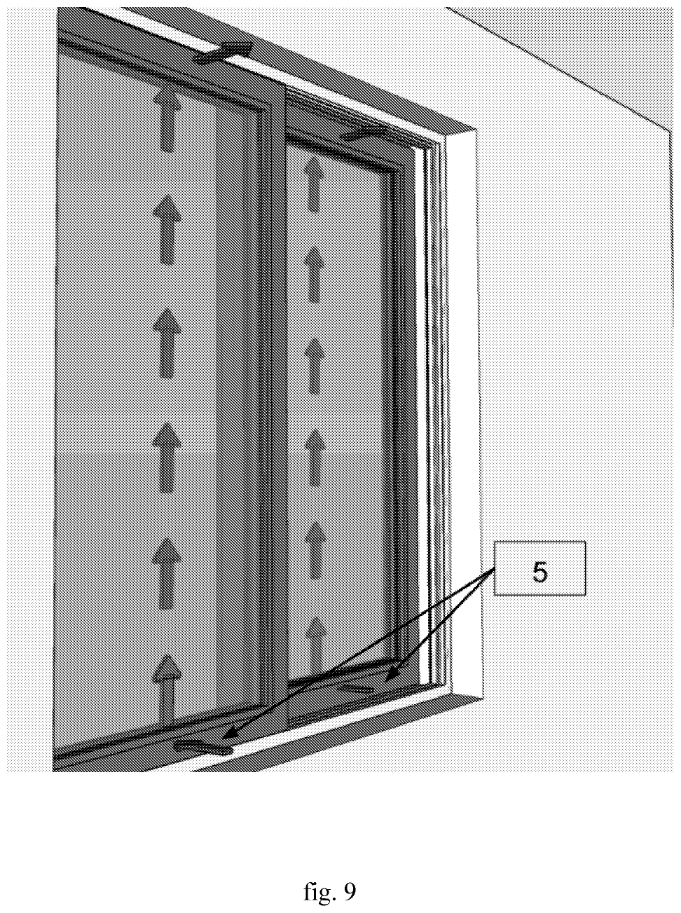

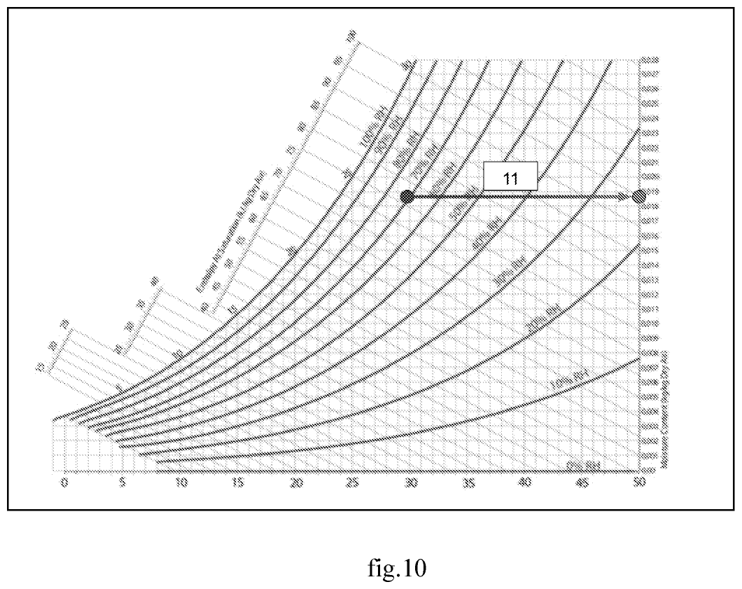

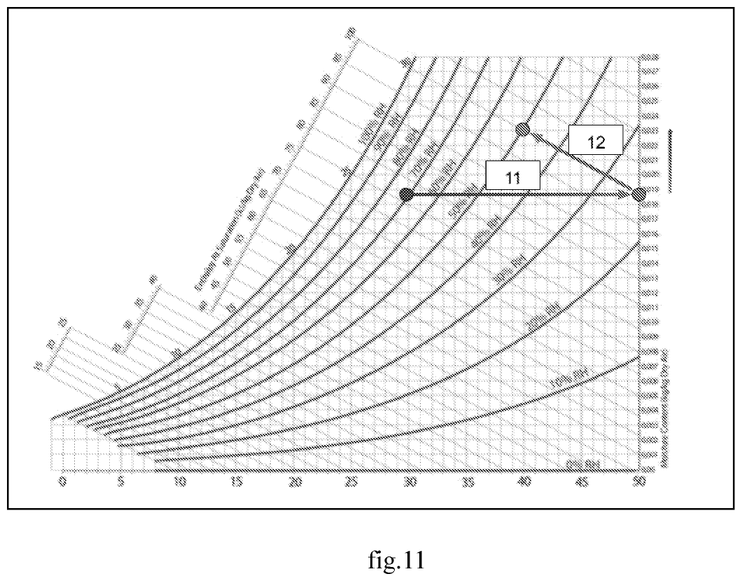

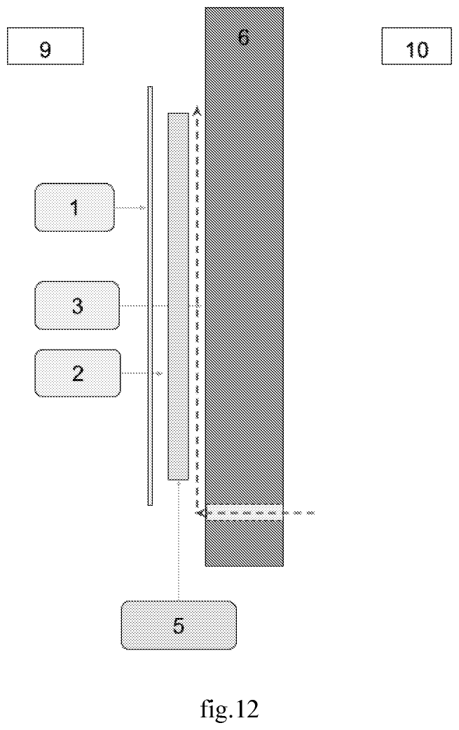

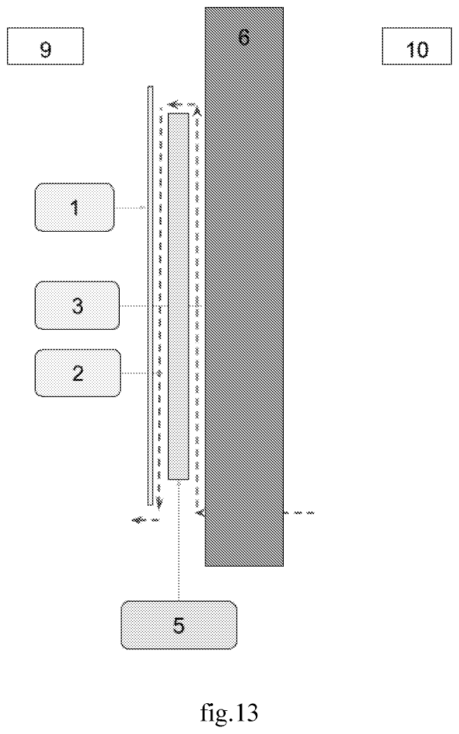

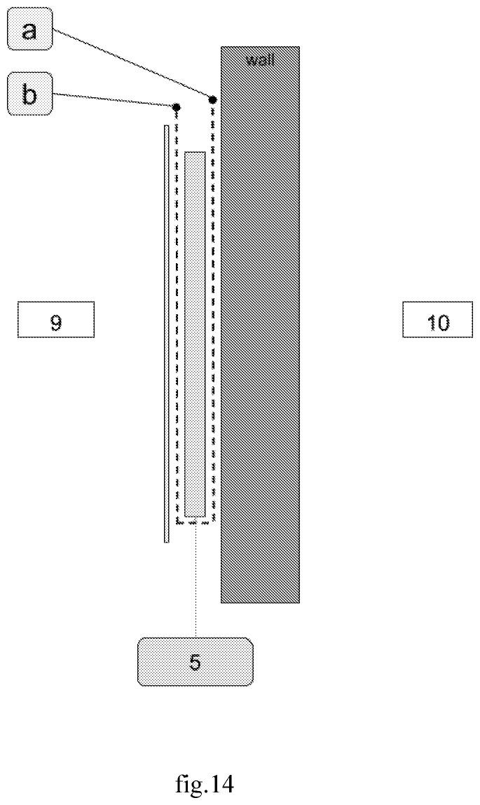

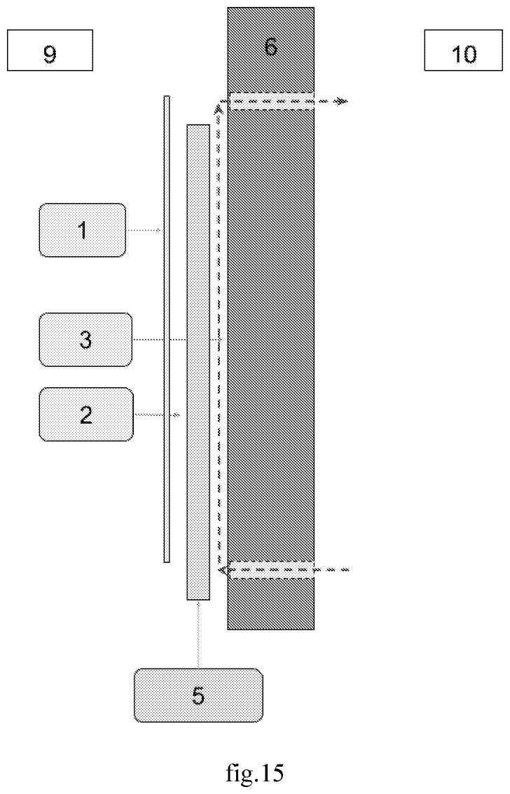

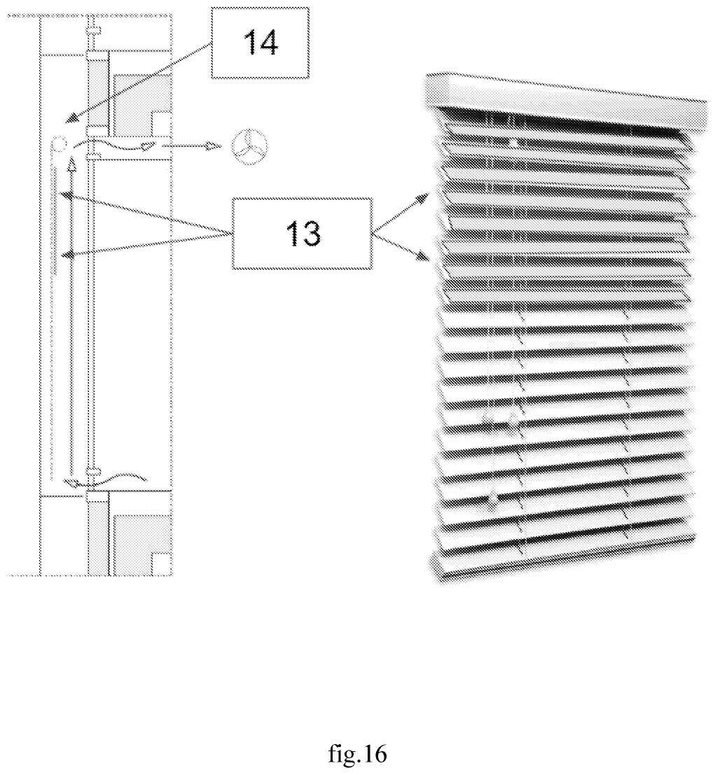

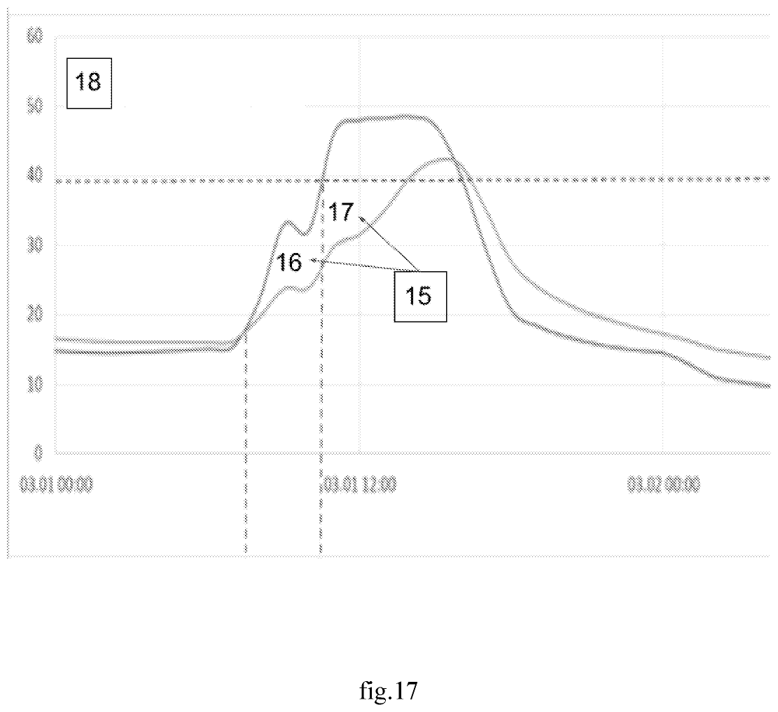

FIG. 9 shows a non-limiting example of applying our innovative idea into windows
5-absorption material unit

FIG. 10 shows the process of sensible heating from 30° C. to 50° C. on a psychrometric chart showing
humidity drops from 70% RH to 25% RH 11-first step: sensible heating of the air in the fasade

FIG. 11 shows the process of evaporative cooling on a psychrometric chart showing that by increasing the humidity from 25% RH to 50% RH temperature drops from 50° C. to 40° C.
11-first step: sensible heating of the air in the fasade,
12-second step: evaporative cooling by the absorptin material

FIG. 12 shows one non-limiting example where indoor air is directed into the air gap between the wall building and the insulation material.
1-fseade, 2-air gap, 3-second air gap, 5-absorption material, 6-wall, 9-outdoor, 10-indoor

FIG. 13,14,15 shows one non-limiting example of airflow.
1-facade, 2-air gap, 3-second air gap, 5-absorption material, 6-wall, 9-outdoor, 10-indoor

FIG. 16 shows a non-limiting embodiment of the integration of the absorption material in blinds used in double skin facade or windows. The blinds can be controlled and in that way, the exposure to the airflow can be restricted.
13-absorption material coating or absorption material blinds, 14-rolled-blind system

FIG. 17 shows a non-limiting example of a water-saving algorithm:
The higher, blue line shows the normal temperature that evolves in the air gap.
The lower, orange line shows the temperature after exposure to the absorption material when there is no control of the air flow or control over the exposure-restriction-means. 15 indicates unnecessary cooling, 16 indicates unnecessary cooling time because temperature didn't reach the threshold (the dashed line at 40° C. in the specific example). 17 indicates unnecessary overcooling because there is no need to cool below the cooling threshold (40° C. in the specific example). 18 indicates the y-axis, temperature in Celsius.

1. double-walled glass insulator comprising:
a. first and second vents adapted for conducting ambient air into and out of said air-gap;
b. at least one absorption material unit containing a volume of absorption material adapted to absorb humidity from the air, said absorption material is in fluid communication with said air-gap;
c. flow control means for conducting ambient air through said first vent into said air-gap, and for conducting air out of said air gap through said second air vent, out to the ambient air;
d. a controller controlling said flow control means, adapted to operate in the following modes:
i. a water-harvesting-mode, wherein said controller operates said flow control such that said absorption material can absorb humidity from the ambient air, when conditions allow it;
ii. waiting-mode, when said controller is not activating said means for facilitating air so said absorption material saturation level does not actively change;
iii. a cooling-mode, when said controller operates said flow control such that said absorption material can release humidity into the air of said air gap, when conditions allow it;
wherein moisture from said absorption material is released into the hot, dry air in said air gap during the day for evaporative cooling, and the cool, moist conditions of the ambient air are used during the night for water harvesting, increasing the moisture content of said absorption material.

2. The system of claim 1, further comprising:
a. at least one set of temperature and relative humidity sensors associated with said controller and deployed for sensing the humidity and temperature of said ambient air;
b. at least one set of temperature and relative humidity sensors associated with said controller and deployed for sensing the temperature and humidity of said air-gap upstream and in adjacent to said absorption material unit;
c. sensing means adapted to determine the absorbed moisture saturation level of said absorption material, said absorbed moisture saturation level being the relative humidity of air in equilibrium with said absorption material;
wherein said controller is configured to operate said modes in according with the following rules:
a. operating said water-harvesting-mode when the relative humidity of the ambient air is higher than said absorbed moisture saturation level of said absorption material;
b. operating said waiting-mode when the relative humidity of the ambient air is lower than said absorbed moisture saturation level of said absorption material, and the temperature in said air gap is lower than a predetermined cooling threshold;
c. operating said cooling-mode when the temperature of said air-gap exceeds said predetermined cooling threshold, and said air-gap relative humidity is lower than said absorbed moisture saturation level of said absorption material;

3. The system in claim 2 further providing flow restriction means adapted for controlling the flow rate of airflow to said absorption material, said controller being further adapted to control said flow restriction means so as to save water during said cooling mode by restricting the airflow to said absorption material to a rate such that the air in said air gap is cooled only to said predetermined cooling threshold but no lower.

4. The system of claim 3 adapted for use in an air-gap employing a rolled-blind system, wherein said absorption material is carried on said rolled-blind system, and wherein said controller further controls the rolling and unrolling of said rolled-blind system such that said absorption material can be saturated by ambient humid air or evaporate water when conditions permit.

5. The system in claim 1 further comprising:
a. a third vent in fluid communication with the indoor air of the structure employing said double-walled glass insulator, said third vent being controlled by said controller;
b. at least one set of temperature and relative humidity sensors associated with said controller, deployed for sensing the temperature and relative humidity of said indoor air;
wherein said controller is further configured to operate a fourth mode in which said indoor air is forced through said absorption material and said air-gap, and then out to the ambient through said second vent, thereby allowing use of cold, dry indoor air for further evaporative cooling in said air gap.

6. The system in claim 1 wherein said absorption material unit comprises one or more of the following:
a. a ventilated container filled with particles of absorption material so disposed as to facilitate airflow past said particles;
b. a volume of absorption material that is highly porous, allowing said airflow to pass through it;
c. a volume of absorption material placed inside said air gap, wherein said airflow flows over the surface of said absorption material such that there is minimum restriction of said airflow;
d. a container having at least two vents allowing air to flow from said air gap and back to said air gap;
and wherein said absorption material is characterised by one or more of the following:
a. having projections adapted for increasing surface area;
b. being transparent;
c. having decorative purpose.

7. The system in claim 1 or 2 wherein said absorption material unit is placed in one of the following locations:
a. inside said air gap such that at least part of the airflow that passes through said gap flows through said absorption material;
b. in the frame that supports the glass of said double-walled glass insulator;
c. in the frame that supports the glass of said double-walled glass insulator, wherein at least part of the frame is used for transporting air to and from said absorption material;
d. inside said air gap of said double-walled glass insulator, located at floor or ceiling height such that said absorption material unit does not block the view through said double-walled glass insulator;
e. outside said air gap, said absorption material unit being provided with air channels allowing air to flow from and back to said air gap.

8. The system of claim 1 wherein said absorption unit comprises a sealed container having at least two unit-vents adapted to control air flow electronically, wherein said first unit-vent allows said air gap air to enter the unit and the second unit-vent the air allows said air gap air to leave the unit and the said controller is further controlling said unit-vents.

9. The system of claim 1, used to cool building-integrated photovoltaics.

10. The system of claim 1, wherein said controller is configured to operate in a further heating-mode when said air-gap temperature is below a certain predetermined heating threshold and the relative humidity of said ambient air or said indoor air is higher than said absorbed moisture saturation level of said absorption material.

11. A water-harvesting evaporative-cooling system adapted for cooling the air gap of a ventilated air gap construction, comprising;
a. at least one absorption material unit containing a volume of moisture absorbent material in fluid communication with said air-gap;
b. means for facilitating airflow originating from ambient air, through said ventilated air gap;
c. a controller being operatively connected to said means for facilitating airflow, configured to operate in the following modes;
i. water-harvesting-mode, wherein said controller operates said means for facilitating airflow such that said absorption material absorbs humidity from said ambient air, when conditions allow it;
ii. waiting-mode, wherein said controller prevents air flow, such that said absorption material does not absorb humidity from said ambient air;
iii. cooling-mode, wherein said controller operates said means for facilitating air flow such that said absorption material can evaporate water into said airflow, when conditions allows such;
wherein the low relative humidity of hot air in said air gap is used during the day for evaporative cooling, and the high relative humidity of said ambient air is used during the night for water harvesting thereby increasing the saturation level of said absorption material.

12. The system of claim 11 wherein said airflow occurs past the surface of said absorption material such that humidity is exchanged between said airflow and said absorption material over the surface area of said absorption material unit.

13. The system of claim 11 when further:
a. said absorption material is porous material or said absorption material is arranged in porous structure;
b. said airflow is going through said absorption material, thereby humidity can be exchanged between air and a large surface area of said absorption material.

14. The system of claim 13 further having a second air gap parallel to said air gap closer to the interior of the structure employing said ventilated air gap, said means for facilitating airflow configured to facilitate a flow of air in two directions:
a. a first-airflow-direction wherein said airflow flows from said second air gap to said air gap;
b. a second-airflow-direction when said airflow flows from said air gap to said second air gap;
and wherein said controller is further configured to operate said water-harvesting-mode in said first-airflow-direction and said cooling-mode in said second-airflow-direction in the summertime, such that the heating effects of said water-harvesting-mode does not heat the building in the summertime.

15. The system of claim 11, further comprising:
a. at least one set of temperature and relative humidity sensors associated with said controller deployed for sensing the humidity and temperature of said ambient air;
b. at least one set of temperature and relative humidity sensors associated with said controller deployed for sensing air-gap temperature and air-gap relative humidity of said air-gap air upstream and in adjustment to said absorption unit;
c. means for evaluating the saturation level of said absorption material, associated with said controller, said saturation level being the relative humidity of air that is in equilibrium with said absorption material;
and wherein said controller is further configured to operate said modes according to the following rules:
d. operating said water-harvesting-mode at night or when heating said air-gap is allowable, if the relative humidity of said ambient air is higher than said absorption material saturation level;
e. operating said waiting-mode when there is no need for cooling and the relative humidity of said ambient air is lower than said saturation level of said absorbent material;
f. operating said cooling-mode if said air-gap temperature exceeds a certain predetermined cooling threshold and the relative humidity of said ambient air is lower than the saturation level of said absorbent material.

16. The system of claim 11 further providing exposure-restriction-means adapted to control the flow rate of said airflow through said absorption material, and wherein said controller employs a water-saving-algorithm cooling said airflow to said predetermined threshold and no lower, thereby saving moisture in said absorbent material.

17. The system of claim 11 further comprising:
a. a third vent creating an air path between the indoor air and said air-gap said third vent is associated with said controller;
b. at least one set of temperature and relative humidity sensors associated with said controller and deployed for sensing indoor temperature;
and said controller further configured to operate fourth mode when said indoor air is facilitated to flow to said air-gap interacting with said absorption material and out to said ambient air through said second vent, thereby allowing to explode exout cold and dry indoor air for further evaporative cooling said air gap.

18. The system in claim 1 wherein said absorption material unit comprises one or more of the following:
a. a ventilated container filled with particles of absorption material so disposed as to facilitate airflow past said particles;
b. a volume of absorption material that is highly porous, allowing said airflow to pass through it;
c. a volume of absorption material placed inside said air gap, wherein said airflow flows over the surface of said absorption material such that there is minimum restriction of said airflow;
d. a container having at least two vents allowing air to flow from said air gap and back to said air gap;
and wherein said absorption material is characterised by one or more of the following:
a. having projections adapted for increasing surface area;
b. having decorative purpose.

19. The system in claim 11 when said absorption material unit is placed in one of the following locations:
a. inside said air gap such that at least part of the airflow that passes through said gap flows through said absorption material;
b. in the frame that supports the glass of said double-walled glass insulator;
c. in the frame that supports the glass of said double-walled glass insulator, wherein at least part of the frame is used for transporting air to and from said absorption material;
d. inside said air gap of said double-walled glass insulator, located at floor or ceiling height such that said absorption material unit does not block the view through said double-walled glass insulator;
e. outside said air gap, said absorption material unit being provided with air channels allowing air to flow from and back to said air gap.

20. The system of claim 11 when said absorption material unit comprises a sealed container having at least two unit-vents adapted to control air flow electronically, wherein the first said unit-vent allows air from said air gap to enter said absorption material unit, and the second said unit-vent allows air from said air gap air to exit said absorption material unit, said controller being adapted to control said unit-vents.

21. The system of claim 11 used to cool building-integrated photovoltaics.

22. The system of claim 11 used for heating, wherein said controller is configured to operate in a further heating-mode when said air-gap temperature falls below a predetermined heating threshold, and the relative humidity of said ambient air is higher than said saturation level of said absorbent material.

23. The system of claim 11 wherein said controller is further configured to operate in a pulsed activation mode wherein said airflow is made intermittent.
